(19) United States
(12) Patent Application Publication
(10) Pub. No.: US 2007/0205871 A1
(43) Pub. Date: Sep. 6, 2007

(54) RFID tag clock synchronization

(76) Inventor: Joshua Posamentier, Oakland, CA (US)

Correspondence Address: INTEL CORPORATION;c/o INTELLEVATE, LLC, P.O. BOX 52050, MINNEAPOLIS, MN, 55402, US

(21) Appl. No.: 11/366,788

(22) Filed: Mar. 1, 2006

(51) Int. Cl. H04Q 5/22

(52) U.S. Cl. 340/10.3; 340/10.1; 340/825.2

(57) ABSTRACT

A radio frequency (RFID) reader may modulate a clock signal onto the carrier wave that it transmits to one or more RFID tags, and maintain that clock signal throughout all or most of its transmission (which in some embodiments may also be modulated additionally for the transmission of data). An RFID tag receiving that signal may synchronize its own internal clock to that received clock signal, and use its own internal clock as a reference clock for its own transmission. By continuing to synchronize on the clock signal from the RFID reader, the RFID tag's transmission data rate may be prevented from drifting excessively.

### BACKGROUND

A radio frequency identification (RFID) tag typically receives a radio signal from an RFID reader, and responds to that signal with a modulated transmission that encodes the RFID tag's identification number and possibly other information as well. Many RFID tags are passive devices (i.e., they do not have a self-contained power source, but rather harvest electrical energy from the received radio signal to power the RFID tag's circuitry). Because of this, they typically use very low power clock-generation circuits to act as a timing control for their digital circuitry. However, most very low power clock-generation circuits, due to the nature of their design, cannot hold a clock frequency very long before the clock frequency starts to drift. Therefore, a typical RFID tag may synchronize on a preamble in the received signal to set the clock frequency, and then try to maintain that frequency without further synchronization throughout the tag's transmission. Since the clock speed may immediately start to drift after the preamble has ended, the length of the transmission from the tag may be limited because excessive clock drift may cause the bit rate to change until the data cannot be reliably received by the RFID reader. This effectively reduces the number of applications in which RFID technology may be used because it limits the amount of data that can be transmitted by the RFID tag.

### BRIEF DESCRIPTION OF THE DRAWINGS

Some embodiments of the invention may be understood by referring to the following description and accompanying drawings that are used to illustrate embodiments of the drawings:

FIG. 1 shows a graph of signals that may be combined in an RFID reader, according to an embodiment of the invention.

FIG. 2 shows an RFID reader and an RFID tag, according to an embodiment of the invention.

FIG. 3 shows a flow diagram of a method that may be performed by an RFID reader, according to an embodiment of the invention.

FIG. 4 shows a flow diagram of a method that may be performed by an RFID tag, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “wireless” may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The term “mobile wireless device” may be used to describe a wireless device that may be moved while it is communicating.

Within the context of this document, an RFID tag may be defined as comprising an RFID antenna (to receive an incoming wireless signal that serves to activate the RFID tag, and to transmit a wireless response in the form of a modulated radio frequency signal), and an RFID tag circuit (which may include circuitry to store an identification code for the RFID tag, circuitry to transmit that code through the antenna, and in some embodiments a power circuit to collect received energy from the incoming radio frequency signal and use some of that energy to power the operations of the RFID tag circuit). As is known in the field of RFID technology, “transmitting” a signal from an RFID tag may include either: 1) providing sufficient power to the antenna to generate a signal that radiates out from the antenna, or 2) reflecting a modulated version of the received signal. Within the context of this document, an RFID reader may be a device that wirelessly transmits a signal to the RFID tag to cause the RFID tag to wirelessly transmit the aforementioned response, which may be received by the RFID reader to identify the RFID tag.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

Various embodiments of the invention may modulate a clock signal onto the transmission from an RFID reader, and maintain that clock signal throughout most or all of the transmission from the RFID reader. The RFID tag may receive the transmission from the RFID reader, synchronize its own internal clock with the received clock signal, and continue synchronizing its own internal clock on that received clock signal, even while the RFID tag is transmitting its response. Because stability in this internal clock now depends on an external source, the RFID tag's clock circuitry may be made very simple, with corresponding low power consumption, and still maintain the type of frequency stability that is normally associated with clock circuits that are more complex, more expensive, and consume more power. In turn, the greater stability in frequency may allow the RFID tag to reliably transmit longer responses than would otherwise be feasible when using a free-running clock that was only synchronized initially at the beginning of the transmission from the RFID reader.

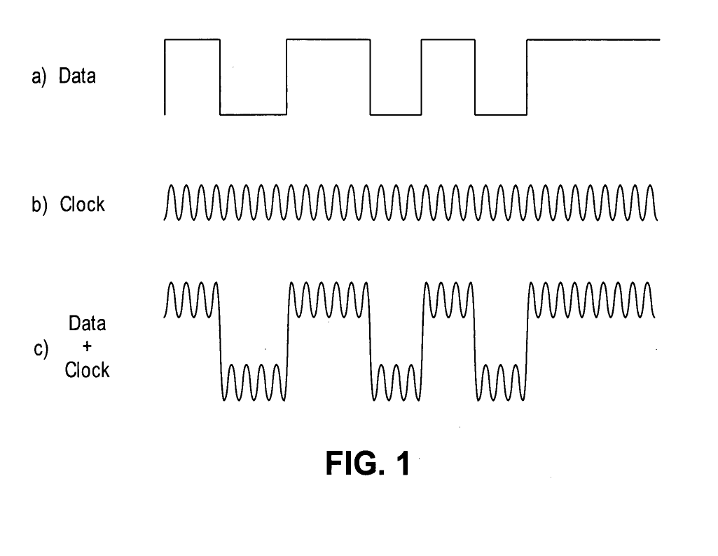

FIG. 1 shows a graph of signals that may be combined in an RFID reader, according to an embodiment of the invention. Line a) of FIG. 1 shows a binary data stream that may be generated in the RFID reader, representing a series of 1's and 0's. In various embodiments the data stream may conform to any of various standards, such as but not limited to: 1) direct binary (e.g., a high represents a 1 and a low a 0, or vice versa), 2) return to zero (RZ), 3) non-return to zero (NRZ), 4) etc. Various parts of the data stream may be used for any feasible purpose, such as but not limited to: 1) a preamble for synchronization by the receiver, 2) message content, 3) address(es), 4) information to be used to interpret other parts of the data, 5) etc. In some embodiments the data rate may be between 40 kilobits per second (KBS) and 640 KBS, but other embodiments may use data rates outside this range.

Line b) of FIG. 1 shows a clock signal. Although the illustrated embodiment is shown as a sine wave, in various embodiments the clock signal may take other forms, such as a square wave, a sawtooth wave, etc. Line c) of FIG. 1 shows a combination of the data stream of line a) and the clock signal of line b), representing both the data stream and the clock signal in a single signal. For ease of illustration, FIG. 1 shows a clock signal with a frequency that is only a few times greater than the effective bit rate of the data, but any feasible ratio of clock frequency to bit rate may be used. In some embodiments, the ratio of clock frequency to bit rate is such that filter circuits in a receiver may be used to separate the clock frequency and the data signal into two separate signals. In some embodiments the clock frequency may be approximately 1 kilohertz (KHz), but other embodiments may use other clock frequencies. In some embodiments, different clock frequencies may be used in different transmissions.

The strength of the clock signal may be any feasible fraction of the strength of the data signal. One embodiment may use a clock signal that is approximately −9 dBc below the strength of the data signal, but other embodiments may use other relative signal strengths.

For wireless transmission, the signal of line c) may be modulated onto a radio frequency (RF) carrier wave. For clarity of illustration, the carrier wave is not shown in FIG. 1, as techniques for modulating carrier waves are well known. Various methods of modulation may be used, such as but not limited to: 1) amplitude shift key (ASK) modulation, 2) phase shift key (PSK) modulation, 3) binary phase shift key (BPSK) modulation, 4) etc. The data and clock signals may be modulated onto the RF signal in any order, such as: 1) modulating the combined data/clock signal onto the RF carrier wave, 2) modulating the data signal onto the RF carrier wave, and then modulating the clock signal onto the modulated carrier wave, 3) modulating the clock signal onto the carrier wave and then modulating the data signal onto the modulated carrier wave. In some embodiments the RF carrier wave frequency may be approximately 900 megahertz (MHz), but other embodiments may use other frequencies.

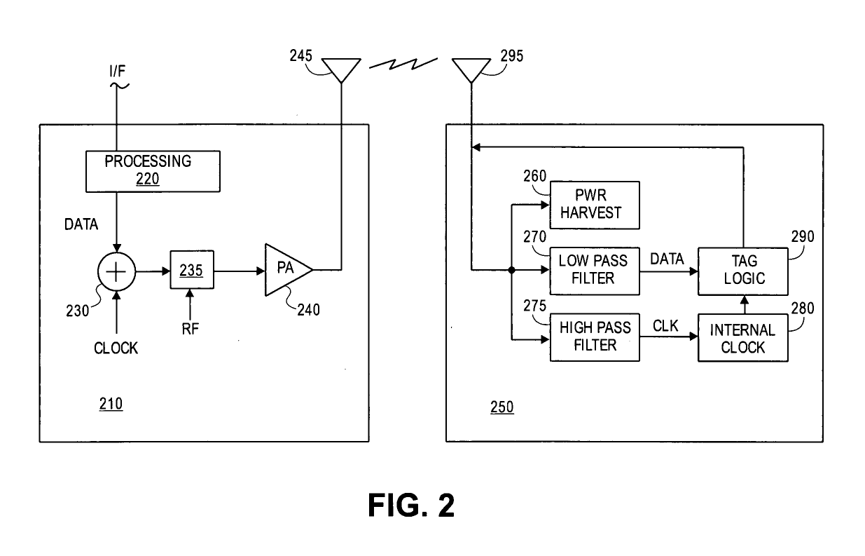

FIG. 2 shows an RFID reader and an RFID tag, according to an embodiment of the invention. RFID reader 210 may send wireless signals through its antenna 245, those wireless signals comprising an RF signal modulated with both a data signal and a clock signal. Those signals may be received by RFID tag 250 through its antenna 295, the clock signal extracted and used to time a response by the RFID tag 250 in which the response timing is synchronized to the extracted clock signal. The response may be received by the RFID reader 210 through its antenna 245. The response may contain an identification number for the RFID tag modulated into the response. As is common with RFID technology, the RFID tag may be attached to an object (not shown), and the tag's identification number may be associated with that object.

The RFID reader 210 may comprise processing logic 220, which in some embodiments may include a processor. Processing logic 220 may perform various operations, such as but not limited to data manipulation, data analysis, communications control, wired or wireless interface to other devices, etc. RFID reader 210 may also comprise combinatorial circuitry 230 to combine the data signal and clock signal, modulation circuitry 235 to modulate an RF carrier wave with the data and/or clock signal, and power amplifier 240 to amplify the modulated carrier wave to a sufficient power level that it can be transmitted through antenna 245.

The RFID tag 250 may comprise power harvesting circuit 260 to accumulate some of the electrical energy from the received RF signal and provide that electrical energy to power other parts of RFID tag. RFID tag 250 may also comprise low pass filter 270 to extract the data signal from the received RF signal, and tag logic 290 to receive that data and control the RFID tag's response. RFID tag 250 may also comprise high pass or band pass filter 275 to extract the clock signal from the received RF signal, and tag clock circuit 280 to derive an internal clock from that clock signal to operate the tag logic 290. In one embodiment, the extracted clock signal may generate the internal clock relatively directly through simple buffers and/or clock division circuitry. In other embodiments, a phase locked loop (PLL), oscillator, or other similar type circuit may produce the internal clock, and use the extracted clock signal as a reference for frequency synchronization. The latter technique has the advantage of continuing to run accurately for short periods when the extracted clock signal is missing (e.g., due to RF interference or weak RF signal), but may require more complicated circuitry than the first technique.

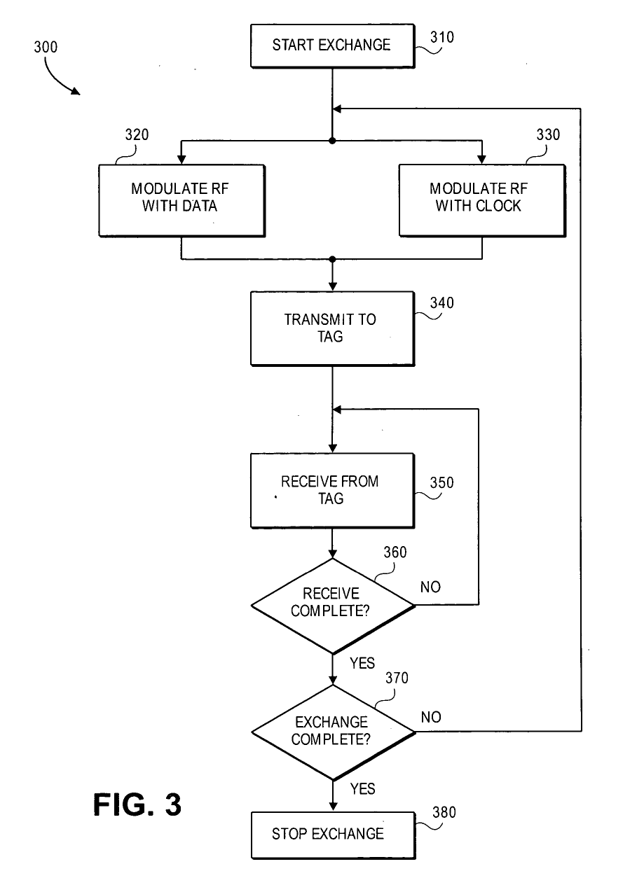

FIG. 3 shows a flow diagram of a method that may be performed by an RFID reader, according to an embodiment of the invention. In flow diagram 300, a communications exchange may be started at 310. In preparation for a transmission, an RF carrier wave may be modulated with a data signal at 320 and modulated with a clock signal at 330. These two operations may be handled in parallel (as implied by the split flow in FIG. 3) or sequentially, but the result may be an RF carrier wave that is modulated with the clock signal and with any data signal that may be operable at that time. During some time periods there may be no data to transmit, and during those time periods the RF carrier wave may be modulated only with the clock signal, or with the clock signal and a non-changing data level. In some embodiments, no data may ever be sent (e.g., the carrier wave is intended to energize all RFID tags within range, with no singulation or tag inventory process and no data transfer to the tags), and in those embodiments the RF carrier wave may be modulated only with the clock signal.

The modulated carrier wave may then be transmitted at 340, and received by an RFID tag. (It may be received by multiple RFID tags, but for simplicity of explanation, only one tag is described). At 350, a response may be received from the RFID tag. The transmission from the RFID reader at 340 may continue while the response is being received from the RFID tag at 350. Once the response has been received at 360, the RFID reader may process the data that was contained in the response. In some exchanges, the RFID reader may transmit more data (e.g., address, command, instructions, etc.) to the RFID tag as a part of the same communications exchange, in which case the operation of flow diagram 300 may revert back to operations 320/330 without stopping the transmission at 340. But if the exchange is complete, operation of the flow diagram may be stopped at 380.

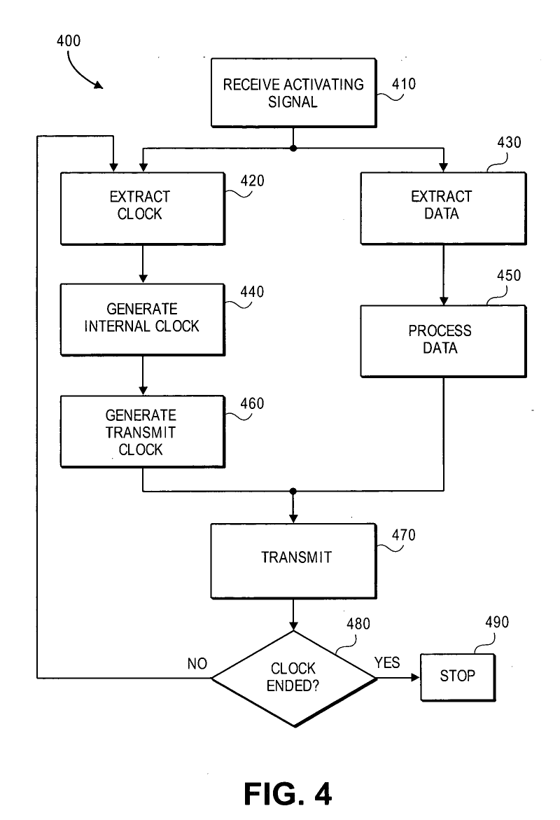

FIG. 4 shows a flow diagram of a method that may be performed by an RFID tag, according to an embodiment of the invention. In flow diagram 400, an activating signal may be received at 410, where ‘activating’ indicates that the RFID tag is somehow prompted to respond. In some embodiments this may simply be that a carrier wave signal with the proper frequency, strength, and duration is received so that the RFID tag is energized sufficiently to respond, e.g., as in a tag-talk-first protocol. In other embodiments, ‘activating’ may require that the signal be modulated with an address or other information that indicates this particular RFID tag is being prompted to respond, e.g., as in a reader-talk-first protocol. Once activated by an incoming signal, the circuitry in the RFID tag may process the received RF signal to extract the clock signal at 420 and extract the data signal at 430, where such signals were contained in the incoming RF signal. The RFID tag may use any feasible means to extract those signals, such as but not limited to any combination of demodulation, low pass filtering, high pass filtering, and/or band pass filtering.

When a useable clock signal is extracted, the RFID tag may use that extracted clock signal to generate an internal clock at 440 with a defined frequency relationship to the extracted clock signal. In various embodiments, the internal clock may have the same frequency, a lower frequency, or a higher frequency, than the extracted clock signal. In various embodiments, the phase of the internal clock may or may not have a defined relationship to the phase of the extracted clock signal. This internal clock may be used as a clocking signal for some or all of the digital logic in the RFID tag. This internal clock may also be used to generate a transmission clock at 460, to control the data rate of the transmission from the RFID tag. In some embodiments the transmission clock will have the same frequency as the internal clock (and effectively may be the internal clock), but other embodiments may use other techniques, such as making the internal clock's frequency a defined multiple of the transmission clock's frequency.

If data has been extracted from the incoming RF signal at 430, that data may be processed by the RFID tag at 450, and the subsequent actions of the RFID tag may depend on the results of that processing. For example, if the first part of the data includes a synchronizing preamble, the RFID tag may synchronize on that preamble to determine the boundaries of subsequent bits, bytes, addresses, commands, information, etc. that may follow the preamble. If the data includes a destination address, the RFID tag may decode the address to determine if it should respond at all. Other types of data may cause other types of actions by the RFID tag.

If a response by the RFID tag is called for, the RFID tag may respond by transmitting at 470. The transmission may be controlled by the aforementioned transmission clock. At 480, if the incoming RF signal from the RFID reader continues to be received and continues to contain a clock signal (as indicated by the loop 420-440-460-470-480), the frequency of the resulting transmission clock may continue to be controlled by the frequency of the incoming clock signal. In some operations, when the clock from the RFID reader is no longer received, the process may be stopped as indicated at 490. In alternate operations, the RFID tag may continue to transmit for some time, using its clock circuit in a free-running mode to provide a transmit clock. This can be especially valuable when it allows the transmission to continue during short periods when the incoming clock signal is not reliably received, due to factors such as interference or a weak incoming signal.

The foregoing description has focused on using a clock transmitted by the RFID reader to control the clock speed of the response transmitted by an RFID tag. However, other embodiments may also use the clock transmitted from the RFID reader to synchronize the receiving circuitry of the RFID tag so that it also will not drift excessively.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising
a radio frequency identification (RFID) reader device adapted to:
generate a radio frequency carrier wave signal; and
modulate the carrier wave signal with a clock signal to be used as a clock reference by an RFID tag.

2. The apparatus of claim 1, wherein the reader device is further adapted to produce the carrier wave signal modulated with the clock signal and a data signal simultaneously.

3. The apparatus of claim 1, wherein at least a part of the data signal is configured to be a preamble for a wireless transmission to an RFID tag.

4. The apparatus of claim 3, wherein the clock signal is to be used as a reference clock to control a data rate of a wireless transmission by the RFID tag.

5. The apparatus of claim 4, wherein the carrier wave signal is to be modulated with the clock signal during substantially all of the wireless transmission by the RFID tag.

6. The apparatus of claim 3, further comprising a dipole antenna coupled to the RFID reader device.

7. An apparatus comprising
a radio frequency identification (RFID) tag device adapted to:
receive a radio frequency carrier wave signal modulated with a clock signal;
demodulate the radio frequency carrier wave signal to obtain the clock signal; and
use the clock signal to control a data rate in a transmission from the RFID tag.

8. The apparatus of claim 7, wherein the RFID tag is further adapted to demodulate a data signal from the radio frequency carrier wave signal.

9. The apparatus of claim 7, wherein the RFID tag is further adapted to modulate the transmission from the RFID tag with an identification number of the RFID tag.

10. The apparatus of claim 9, further comprising an object coupled to the RFID tag, the object to be associated with the identification number.

11. A method, comprising:
modulating a carrier wave signal with a clock signal in a radio frequency identification (RFID) devise;
transmitting the modulated carrier wave to an RFID tag; and
receiving a response from the RFID tag, the response having a data rate synchronized with the clock signal in the RFID tag.

12. The method of claim 11, further comprising modulating the carrier wave signal with a data signal in the RFID device.

13. The method of claim 11, wherein said modulating the carrier wave comprises modulating the carrier wave during at least a portion of said receiving the response.

14. A method comprising:
receiving a radio frequency signal from a radio frequency identification (RFID) reader device, the radio frequency signal modulated with a clock signal.

15. The method of claim 14, comprising:
demodulating the radio frequency signal to obtain the clock signal; and
synchronizing a bit rate of a transmission with the clock signal, while continuing to receive the modulated clock signal.

16. The method of claim 15, further comprising using the clock signal as a reference to control a frequency of an internal clock circuit.

17. An article comprising
a tangible machine-readable medium that contains instructions, which when executed by one or more processors result in performing operations comprising:
enabling a carrier wave to be modulated with a clock signal;
enabling the modulated carrier wave signal to be transmitted; and
enabling reception of a transmission from an RFID tag while the modulated carrier wave signal is being transmitted.

18. The article of claim 17, wherein the operation of enabling reception comprises enabling reception at a bit rate controlled by a frequency of the clock signal.

19. The article of claim 17, wherein the operation of enabling a carrier wave further comprises enabling the carrier wave with a signal.
